(19) United States
(12) Patent Application Publication
(10) Pub. No.: US 2021/0127703 A1
(43) Pub. Date: May 6, 2021

(54) FOOD PRODUCT USING AN IMPROVED SUGAR

(71) Applicant: Mesmer Chocolate LLC, Indianapolis, IN (US)

(72) Inventor: Stephen Fraser, Indianapolis, IN (US)

(73) Assignee: Mesmer Chocolate LLC, Indianapolis, IN (US)

(21) Appl. No.: 17/085,592

(22) Filed: Oct. 30, 2020

Related U.S. Application Data
(60) Provisional application No. 62/928,817, filed on Oct. 31, 2019.

(51) Int. Cl. A23G 1/48; A23G 1/50; A23L 29/00; A23L 29/30; A23L 27/00; A23L 27/10; A23G 1/40

(52) U.S. Cl. CPC A23G 1/48; A23G 1/50; A23L 29/035; A23G 1/40; A23L 27/88; A23L 27/10; A23L 29/30

(57) ABSTRACT

A food product comprising a flavorant, allulose sugar; and cannabinoids is disclosed. The disclosure relates to a chocolate bar, including allulose sugar and CBD oil, and a method for making the same is disclosed.

The present application claims priority and incorporates by reference U.S. Provisional Application No. 62/928,817 filed Oct. 31, 2019, and entitled FOOD PRODUCT USING AN IMPROVED SUGAR.

The present invention relates to a food product, and most typically a confectionary such as a candy bar or otherwise. It includes allulose sweetener, a flavoring (e.g., chocolate or otherwise) and optionally but most preferably, a source of cannabinoid (such as CBD oil). Other variants and additions are possible as well.

### SWEETENER

The sweetener is preferably inclusive of allulose sugar. More preferably, the sweetener used is primarily allulose as opposed to other sweeteners. Sugars containing fructose and glucose, and other sugars that elevate a human being's blood sugar level (glycemic index) upon consumption are not utilized. Such sugars are known to cause adverse health changes, including insulin resistance and diabetes. In contrast, allulose sugar acts as a sweetener and is a natural sugar, but does not raise the glycemic index and causes no known adverse health effects.

### Flavorant

The food product further includes a flavorant, beyond the sweetener, that is or may be part of the food product carrier or body. A preferred flavorant is chocolate, and more specifically, natural cacao liquor. Natural cacao liquor may comprise less than half of the flavorant, but more preferably comprises fifty percent (50%) or more of the non-sweetener flavorant in the food product. More preferably, the flavorant is one hundred percent (100%) natural cacao, or at least consists essentially of natural bean product. Other flavorants optionally may be used in addition or instead of. These include vanilla (such as natural bean vanilla), food flavorants, and nut butters.

### Optional CBD

Another ingredient in the food product that is optional, but preferred is CBD (cannabidiol). There are over 100 known cannabinoids each with different biologic effects that may be mixed into the food product in a variety of forms. A preferred form is CBD oil, which blends nicely as an emulsion with the other fat based ingredients, such as chocolate liquor. While research by others continues to advance, there are indications that CBD has beneficial health effects when ingested by humans. By consuming CBD in a fat emulsion such as a chocolate confection, absorption and benefit is maximized by avoiding breakdown of CBD by the “first pass effect” in the liver at URL ncbi.nlm.nih.gov/pmc/articles/PMC2689518/ (entitled “Human Cannabinoid Pharmacokinetic”), which reads in part:

“Possibly a more accurate assessment of oral bioavailability of THC in plasma samples was reported by Ohlsson et al., based on GC/MS experiments [5]. The peak THC concentrations ranged from 4.4 to 11 ng/ml, occurring 1-5 h following ingestion of 20 mg of THC in a chocolate cookie; the oral bioavailability was estimated to be 6%. Slow rates of absorption and low THC concentrations occur after oral administration of THC or cannabis. Several factors may account for the low oral bioavailability of 4-20% (as compared to intravenous drug administration), including variable absorption, degradation of drug in the stomach, and significant first-pass metabolism to active 11-OH-THC and inactive metabolites in the liver.

### 2.1.3. Oromucosal

Due to the chemical complexity of cannabis plant material compared to synthetic THC, extracts of cannabis that capture the full range of cannabinoids are being explored as therapeutic medications. Cannabis has been used as medicine for thousands of years [34][35]. Cultivation methods have been developed to reproducibly produce plants with defined THC or CBD concentrations. GW Pharmaceuticals has produced two standardized extract preparations, Tetranabinex®, which is high in THC, and Nabidiolex®, which is high in CBD. Sativex® contains equal proportions of Tetranabinex® and Nabidiolex®, and, hence, almost equal amounts of THC and CBD. THC and CBD represent approximately 70% of the product, with 5% of other cannabinoids, the remainder being terpenoids, flavonoids, sterols, alkanes, and other chemicals [36]. Clinical trials of the efficacy of these extracts are ongoing for analgesia [37][38] and spasticity, and other indications in affected patients [39]. Sativex® is administered sublingually to avoid first-pass metabolism by the liver. Sativex® is approved in Canada for the treatment of neuropathic pain associated with multiple sclerosis, and in three European countries for a number of indications.

### 2.1.5. Transcutaneous

Another route of cannabinoid exposure that avoids first-pass metabolism and improves THC bioavailability is topical administration [43]. Cannabinoids are highly hydrophobic, making transport across the aqueous layer of the skin the rate-limiting step in the diffusion process [44][45]. In vitro diffusion studies may underestimate in vivo transdermal flux [43]. After application of a dermal patch, mean steady-state plasma concentration of Δ8-THC was 4.4 ng/ml within 1.4 h, and was maintained for at least 48 h. Permeabilities of CBD and CBN were found to be 10-fold higher than for Δ8-THC. In vivo studies of transdermal drug delivery in guinea pigs noted the presence of significant amounts of plasma metabolites after topical application of THC [46]. Additional research is planned with combinations of cannabinoids in EtOH to increase drug absorption.

Transdermal delivery of cannabinoids is hoped to reduce negative side effects seen with inhalation dosing [47]. Transdermal delivery also bypasses first-pass metabolism of cannabinoids. These properties could improve the utility of transdermal cannabinoid medications. Applying a transdermal patch several hours before chemotherapy, and wearing it for several days, would be a convenient means for treating associated nausea and vomiting. Also, wearing a patch for a week to stimulate appetite could be a good alternative to twice a day oral dosing of dronabinol.

The drug-abuse potential of cannabinoid transdermal patches is expected to be low because of slow delivery of THC to the brain. However, extraction of cannabinoids from the patch for administration by a more-rapid method has not been evaluated. Diversion of fentanyl patches by drug abusers for use in such a manner has been a significant problem.

### 2.3.2. Extrahepatic Metabolism

Other tissues, including brain, intestine, and lung, may contribute to the metabolism of THC, although alternate hydroxylation pathways may be more prominent [86][101-104]. An extrahepatic metabolic site should be suspected whenever total body clearance exceeds blood flow to the liver, or when severe liver dysfunction does not affect metabolic clearance [102]. Of the ten mammalian classes of CYP 450 systems, the cytochrome families 1-4 primarily metabolize xenobiotics, which are found in the liver, small intestine, peripheral blood, bone marrow, and mast cells in decreasing concentrations, with the lowest concentrations in the brain, pancreas, gall bladder, kidney, skin, salivary glands, and testes. Within the brain, higher concentrations of CYP 450 enzymes are found in the brain stem and cerebellum [102]. The hydrolyzing enzymes—non-specific esterases, β-glucuronidases, and sulphatases—are primarily found in the gastrointestinal tract. Side-chain hydroxylation of THC is prominent in THC metabolism by the lung. Metabolism of THC by fresh biopsies of human intestinal mucosa yielded polar hydroxylated metabolites that directly correlated with time and amount of intestinal tissue [101].

In a study of the metabolism of THC in the brains of mice, rats, guinea pigs, and rabbits, Watanabe et al. found that brain microsomes oxidized THC to monohydroxylated metabolites [103]. Hydroxylation of C(4) of the pentyl side chain produced the most common THC metabolite in the brains of these animals, similar to THC metabolites produced in the lung. These metabolites are pharmacologically active, but their relative activity is unknown . . . .

### 2.3.3. Metabolism of Cannabidiol

CBD Metabolism is similar to that of THC, with primary oxidation of C(9) to the alcohol and carboxylic acid [8][100], as well as side-chain oxidation [88][100]. Like THC, CBD is subjected to a significant first-pass effect; however, unlike THC, a large proportion of the dose is excreted unchanged in the feces [105]. Benowitz et al. reported that CBD is an in vitro inhibitor of liver microsomal drug-metabolizing enzymes, inhibiting hexobarbital metabolism in humans [50]. Others have reported that CBD selectively inhibits THC-metabolite formation in vitro [58]. Hunt et al. reported that the pharmacokinetics of THC were not affected by CBD, except for a slight slowing of the metabolism of 11-OH-THC to THC-COOH [106]. Co-administration of CBD did not significantly affect the total clearance, volume of distribution, and terminal elimination half-lives of THC metabolites. Concentration vs. time curves, and ratios of the maximum average concentration and AUC values for 11-0H-THC/THC, THC-COOH/THC, and THC-COOH/11-OH-THC showed that CBD only partially inhibited the hydroxylation of THC to 11-OH-THC catalyzed by CYP 2C, when data were compared after oral administration of THC alone, as compared to a THC and CBD preparation [107]. THC and CBD concentrations are high in the liver after oral administration, and there is high first-pass metabolism of THC. However, the effect of CBD on hydroxylation of THC was small in comparison to overall variability.”

### Food Carrier

The food carrier may be a variety of combinations of ingredients, such as those conventionally known to make candy bars. Those may optionally include nuts, rice crisps, or other texturants or flavorants or the absence thereof. As but one example, a simple but preferred example is a chocolate bar comprising the following list of ingredients: 30% allulose, 40% chocolate liquor, 30% cacao butter and natural vanilla. The size and shape of the chocolate bar is not limited to rectangular or square shapes, but also may include round, oval, or otherwise. One optional version is to have a chocolate bar (or chip) very thin (one, two, or three millimeters, for example). In this way, the chocolate flavor may be savored for a longer duration in the mouth while yet melting in the mouth and dispensing the CBD. As such, its opportunity for translingual absorption into the bloodstream is enhanced and uptake will be more rapid as compared to ingesting the bar.

### Method

Importantly, the process for combining allulose with natural chocolate liquor with or without the addition of cannabinoids has certain parameters which must be precisely followed. When creating these products, temperatures must be tightly controlled to be more than 36 C and less than 40 C to avoid adverse effects on the allulose and to avoid losing the CBD product via vapor loss and heat degradation. Allulose must not be allowed to refine longer than 25 min in a ball mill or it will degrade and possibly damage the equipment. A maximum refining time of 25 min attains the proper chocolate particle size of 17 to 20 microns. Also, when adding CBD, not more than 30% may be added as distillate or the chocolate product will become too soft and will not crystallize properly.

What is claimed is:

1. A food product comprising:
a flavorant, allulose sugar; and cannabinoids.

2. The food product of claim 1, wherein the food product comprises:
a chocolate bar.

3. The food product of claim 1, wherein the chocolate bar comprises:
a chocolate flavorant consisting essentially of a natural chocolate liquor.

4. The food product of claim 1, wherein cannabinoid is present as CBD oil.

5. The food product of claim 1, wherein the food product comprises a chocolate bar less than about 2 millimeters thick.

6. The food product of claim 2, wherein the chocolate bar comprises: a chocolate flavorant consisting essentially of a natural chocolate liquor.

7. The food product of claim 6, wherein cannabinoid is present as CBD oil.

8. The food product of claim 7, wherein the food product comprises a chocolate bar less than about 2 millimeters thick.

9. The food product of claim 5, wherein cannabinoid is present as CBD oil.

10. The food product of claim 9, wherein the food product comprises a chocolate bar less than about 2 millimeters thick.

11. A method of making a food product comprising the acts of: a) refining chocolate in a temperature controlled container; b) combining allulose sugar with said chocolate; and, c) combining CBD with said chocolate, wherein the temperature during such making is between 36 C and 40 C.

12. The method of claim 11 wherein said food product comprises a chocolate bar less than about 2 millimeters thick.

13. The method of claim 11 wherein said cannabinoid is CBD oil.

14. The method of claim 12 wherein said cannabinoid is CBD oil.
